(19) United States
(12) Patent Application Publication
(10) Pub. No.: US 2014/0066239 A1
(43) Pub. Date: Mar. 6, 2014

(54) V-BELT CONTINUOUSLY VARIABLE TRANSMISSION

(71) Applicant: Mikhail Urievich Artamonov, Moscow (RU)

(72) Inventor: Mikhail Urievich Artamonov, Moscow (RU)

(21) Appl. No.: 14/110,751

(22) PCT Filed: Feb. 10, 2012
(86) PCT No.: PCT/RU12/00086

§ 371 Date: Nov. 15, 2013

(30) Foreign Application Priority Data
Mar. 16, 2011 (RU) 2011109887

(51) Int. Cl. F16H 9/16

(52) U.S. Cl. CPC F16H 9/16
USPC 474/8

(57) ABSTRACT

The V-belt continuously variable transmission comprises a driving pulley and a driven pulley mounted on shafts, each of which pulleys consists of two half pulleys movable in a horizontal plane and provided with radial longitudinal through slots for enabling the half pulleys to mate (penetrate) one another, and a drive belt. Furthermore, each half pulley is in the form of a single component consisting of three solids of revolution with a common axis, which are interconnected as a single unit, two of said solids of revolution being different-sized hollow truncated cones oriented in different directions and connected by their smaller bases, and the third being a hub that is connected to the corresponding shall in such a way as to be able to move along the latter. The technical result of the claimed utility model is enhanced reliability and increased service life.

### CROSS REFERENCE TO RELATED APPLICATIONS

The present patent application is a National stage PCT application No. PCT/RU2012/000086.

### TECHNICAL FIELD OF THE INVENTION

The claimed utility model relates to mechanical engineering, and continuously variable transmissions with flexible connection, in particular. It may be used in drive gears of various vehicles, reduction drives and the like.

### PRIOR KNOWLEDGE

V-belt continuously variable transmissions are presented in patents for invention #1805251, #1384861.

In continuously variable transmissions of this kind the variation range of gear transmission ratio A depends on angle C, maximum possible distance between pulleys B. The smaller is the angle C, the larger is the rotation radius onto which the pulleys (2) of the continuously variable transmission can push the drive belt (1), and the bigger the force that has to be applied to the pulleys, whereupon the smoothness of gear transmission ratio variation decreases. Extension of distance B unavoidably entails extension of the drive belt's width, radically increasing the risks of the deformation of the latter and the breakdown of the whole mechanism (due to the belt's convolving and falling in between the pulleys). Limited variation range of gear transmission ratio is the common deficiency of known continuously variable transmissions.

As the closest prior art we selected the V-belt continuously variable transmission described in the patent for invention KR 100992667.

Its design features enabled it to fix the aforementioned deficiency. However, this V-belt continuously variable transmission has other drawbacks:

The pulleys that contact the belt lack continuous surfaces (in the belt's raised and lowered positions on the pulleys). It should be mentioned that, with the launching of the mechanism, as the driving pulley builds up speed and transmits rotation to the driven pulley via the belt, the belt is under maximum stress. This, and the lack of continuous surfaces in the known V-belt continuously variable transmission, decreases the wear resistance of the belt manifold.

Furthermore, the form of the hubs in the known V-belt continuously variable transmission, and their junction to the half pulleys is inexpedient, as the hubs are joined to the half pulleys by the means of bolted-type connection, thus over elaborating the framework; moreover, half pulleys are in suspended state and lack direct contact with the shaft, therefore being unable to endure significant load for a protracted period of time.

### SUMMARY

The V-belt continuously variable transmission comprises a driving pulley and a driven pulley mounted on shafts, each of which pulleys consists of two half pulleys movable in a horizontal plane and provided with radial longitudinal through slots for enabling the half pulleys to mate (penetrate) one another, and a drive belt. Furthermore, each half pulley is in the form of a single component consisting of three solids of revolution with a common axis, which are interconnected as a single unit, two of said solids of revolution being different-sized hollow truncated cones oriented in different directions and connected by their smaller bases, and the third being a hub that is connected to the corresponding shaft in such a way as to be able to move along the latter.

### BRIEF DESCRIPTION OF THE DRAWINGS

FIG. 1a demonstrates the closest prior art.

FIG. 1b demonstrates initial and final mating of half pulleys during the operation of the claimed apparatus.

FIG. 2 demonstrates three views of the pulley.

FIG. 3 demonstrates the pulleys on the shaft, pulled together to the maximum, forming continuous surface on the periphery of the pulley.

FIG. 4 demonstrates the half pulleys on the shaft that form continuous surface near the center of the pulley, while their mating entails alignment of the lesser bases of the half pulleys.

FIG. 5 demonstrates raised and lowered position of the belt on the pulleys.

FIG. 6 demonstrates partial lateral deformation of the belt contacting discontinuous surface of the half pulleys, creating, the “cog belt” effect.

FIG. 7 demonstrates two half pulleys on the shaft before mating one another.

FIG. 8a demonstrates the drawback in the known V-belt continuously variable transmissions operation in case of the wear-out of the drive belt, namely, the decrease of gear transmission ratio as the acting surface of the drive belt wears out (distance b), in comparison with the unworn belt (distance a).

FIG. 8b demonstrates the inalterability ear transmission ratio in case of the wear-out of the acting surfaces of the drive belt (distance c)

FIG. 9 demonstrates the drive belt 1 with mounted elements 2 (“cog belt effect”).

V-belt continuously variable transmission includes: belt 1 with mounted elements 2, shaft 3 and half pulleys 4.

### DETAILED DESCRIPTION OF THE INVENTION

The purpose of this utility model is the eradication of the aforesaid shortcomings.

The technical result to be achieved with the use of the claimed apparatus is the increase of the wear resistance of the drive belt by means of creating continuous surfaces of the pulleys that contact the belt (in raised and lowered positions of the belt on the pulleys, in particular); owing to this, as the apparatus gets started and gains momentum, the belt, contacting continuous surfaces formed by the half pulleys, is able to creep over them in case of a jerk or an overload.

Manufacturing the hub and half pulleys as a single component (as a complete unit) enhances overall design integrity, in addition to lessening the load that falls on hubs; as a result, the size of half pulleys may be increased if necessary (to improve gear transmission ratio) without fear of a breakdown.

Concurrently, the variation range of gear transmission ratio remains extended thanks to the half pulleys' mating (penetrating) each other.

The technical effects in question are achieved by the following means: V-belt continuously variable transmission consists of driving pulley and driven pulley mounted on shafts, each of which pulleys consists of two half pulleys that are movable in a horizontal plane, on which there are radial longitudinal through slots enabling the half pulleys to mate (penetrate) one another, and a drive belt, with that each half pulley is designed as a single component that consists of three solids of revolution with a common axis, which are interconnected as a single unit, two of said solids of revolution being different-sized hollow truncated cones oriented in different directions and connected by their smaller bases, and the third being a hub that is connected to the corresponding shaft in such a way (for example, by the means of spline joint or by any other known method) as to be able to move along the latter; and is designed as a hollow cylinder, the diameter of which coincides with the smaller base of the cones, the cylinder being adjoined by one of its tips to the lesser base of the bigger cone, whereas cut slots on the halt pulleys are cut from the bigger base of the lesser cone, not reaching the bigger base of the bigger cone, and on each of the hubs, from the tip joined to the lesser base of the bigger half pulley and not reaching the other tip, corresponding longitudinal through slots are cut, which enable the half pulleys to mate (penetrate) one another while forming continuous surface at the center of the pulley, as the half pulleys mate (penetrate) each other up to the alignment of the lesser bases of half pulleys, and forming continuous surface on the periphery of the pulley, as the half pulleys fully mate (penetrate) one another; furthermore, drive belt is to be made from flexible materials, enabling partial deformation of its surfaces that contact the surface of the pulleys.

Manufacture of the drive belt from flexible materials, enabling partial deformation of its surfaces that contact the surface of the pulleys, also improves the belt's contact with the discontinuous surface of the pulleys, and increases frictional force between them, as well. (“cog belt” effect is achieved).

On the surfaces of the drive belt that contact the surfaces of the half pulleys, along the whole length of the drive belt, mutually adjoining metal components may be installed—for example, plates or rods fixed on the drive belt by the means of adhesive layer or by any other known technique.

It should be noted that the mounting of metal components on the drive belt increases the latter's wear resistance owing to the elimination of the belt's direct contact with the half pulleys; in addition, sidewise displacement of metal components enables the “cog belt” effect, furthermore, the efficacy of drive belt's adhesion to the half pulleys is improved owing to metal-with-metal (instead of metal-with-belt) contact.

### Preferred Embodiment

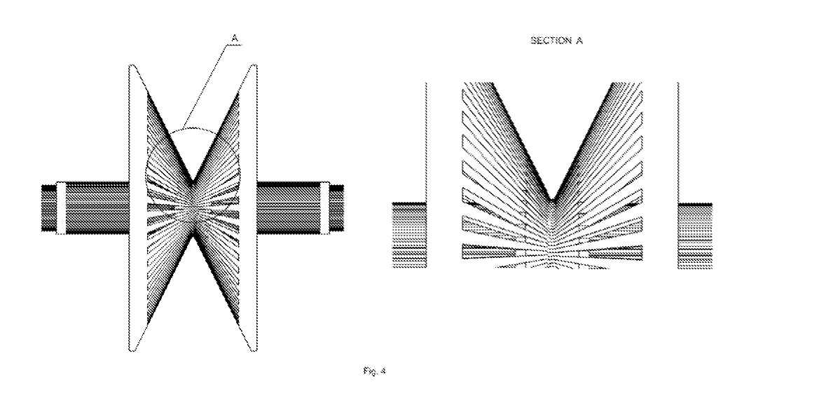

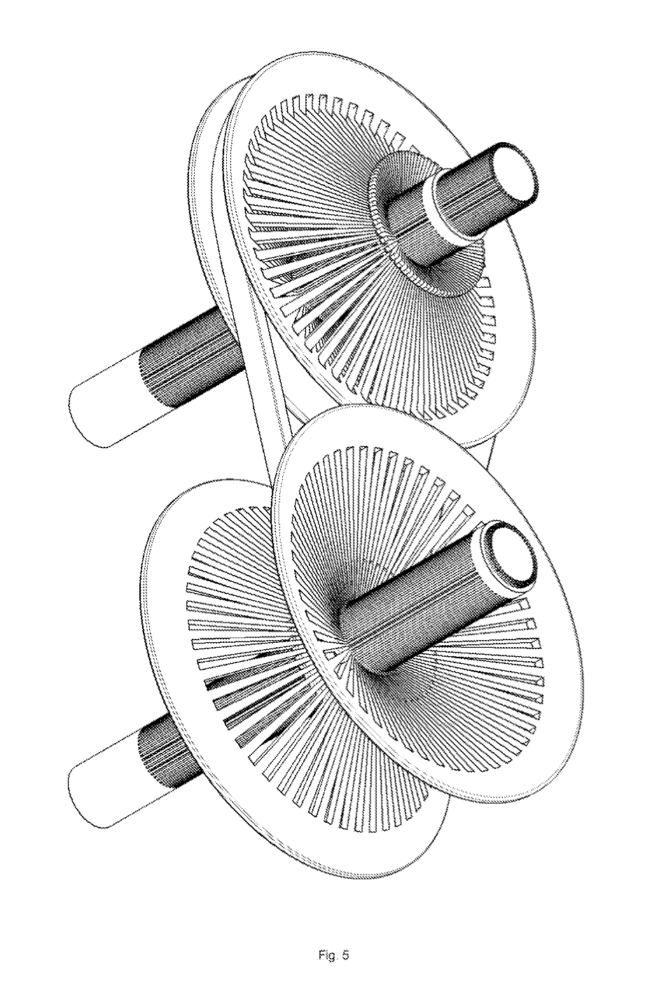

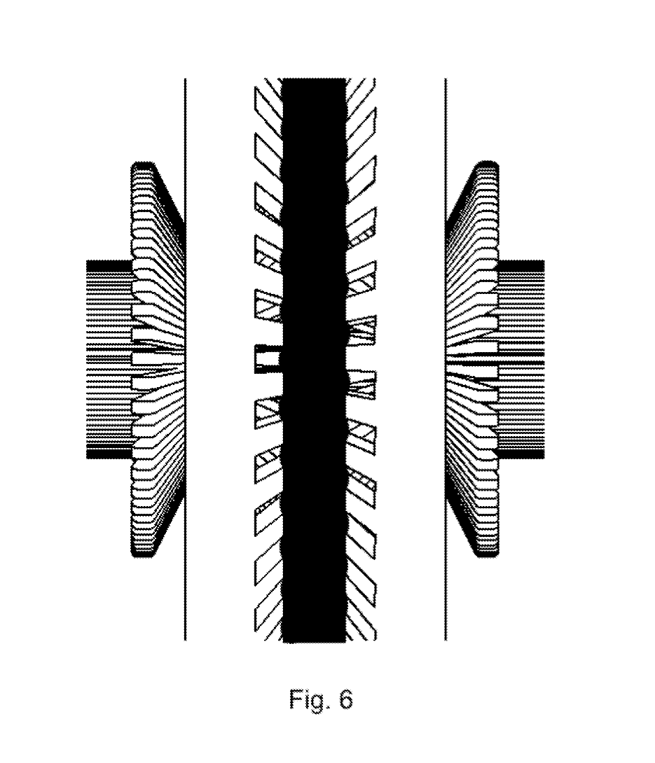

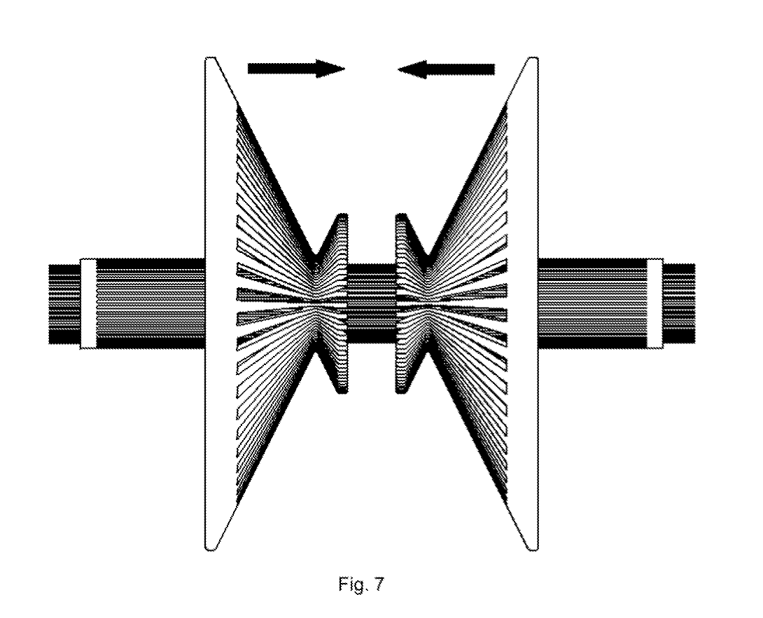

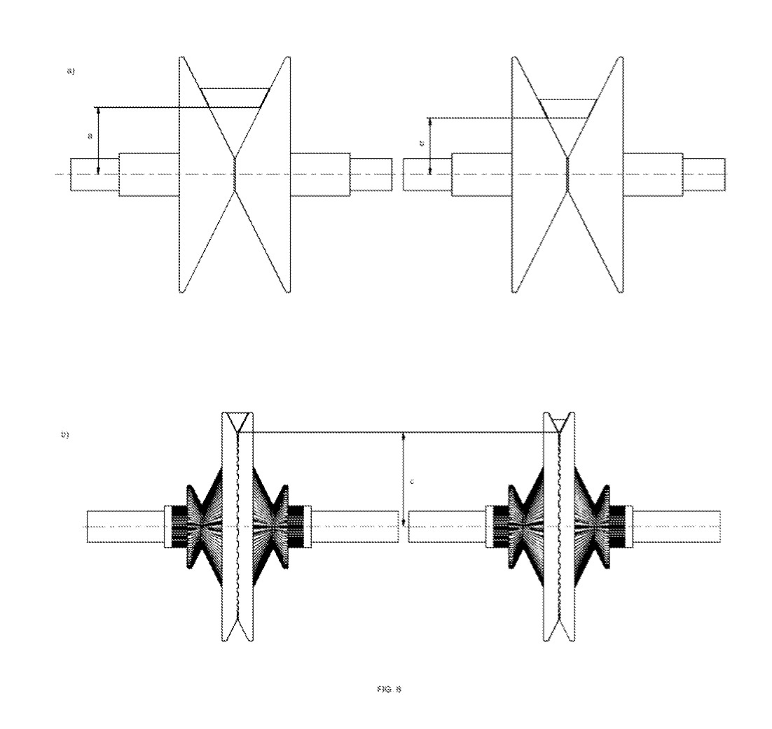

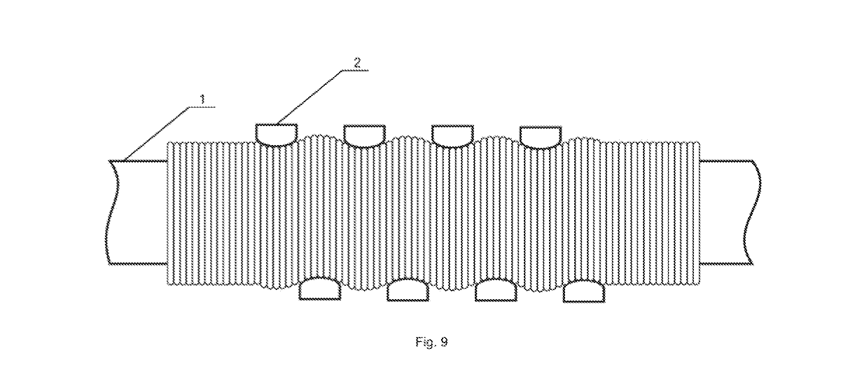

Before the operation begins, the driving and driven pulleys are assembled by the means of mating (penetrating) the half pulleys to each other (see FIG. 4).

The claimed V-belt continuously variable transmission operates in the following way:

As the engine runs, rotational motion of the driving pulley is transferred to the drive pulley by the belt. As the half pulleys mate through radial longitudinal slots of the half pulleys and longitudinal through slots on the hubs of the driven pulley, the belt is forced out to the periphery of the pulley, while on the driving pulley it moves to the center and moves apart the driving pulley. The speed on the driven pulley decreases. And vice versa: when the half pulleys of the driven pulley disengage, the belt moves to the center, reducing the diameter of the driven pulley, whereas on the driving pulley the belt is forced out to the periphery of the pulley, increasing its diameter—and this increases the rotational rate of the driven pulley.

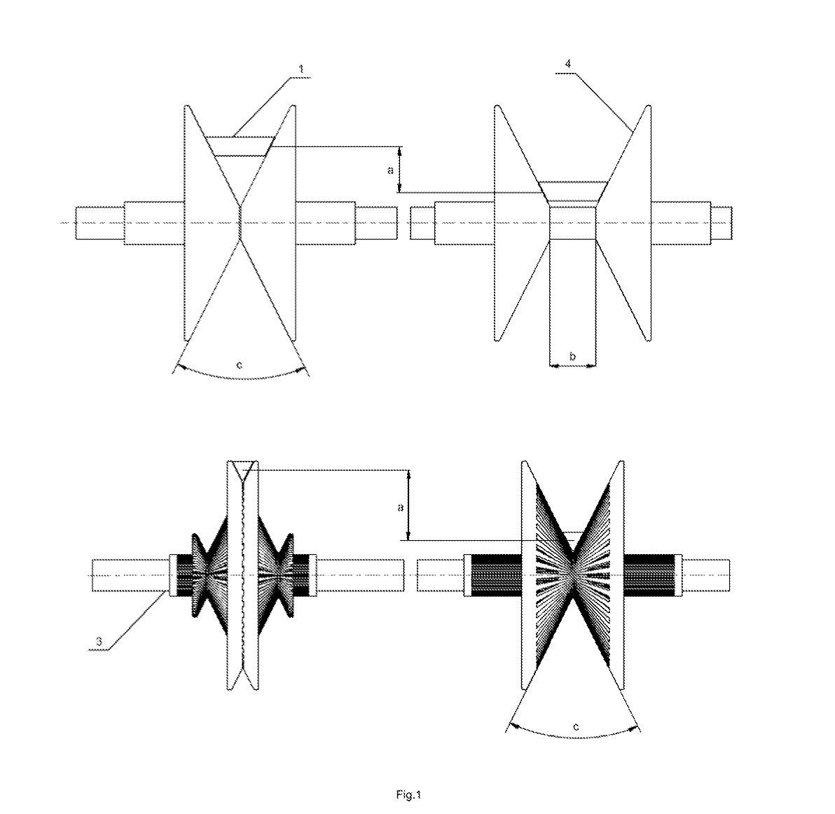

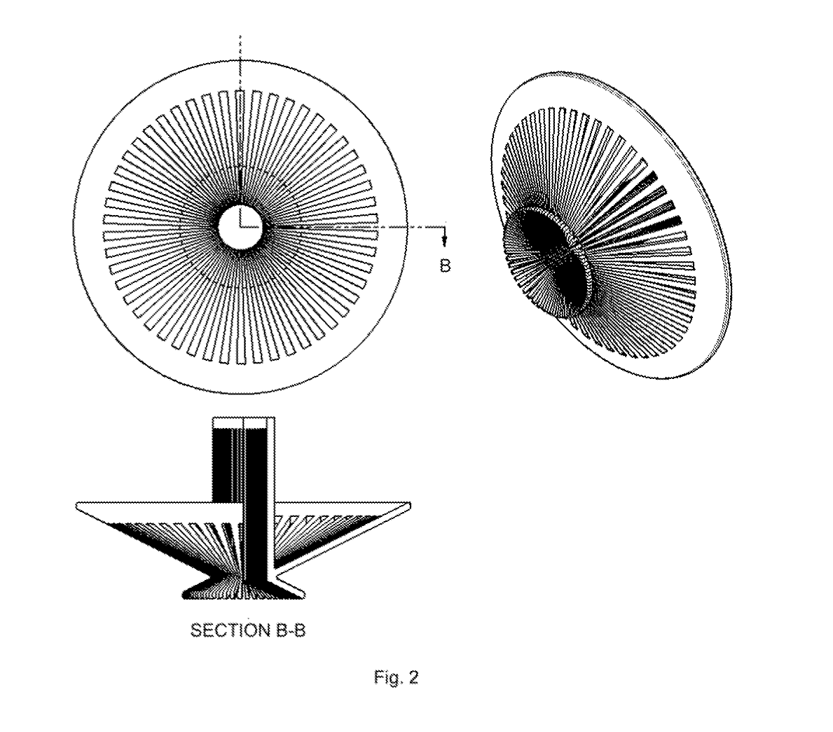

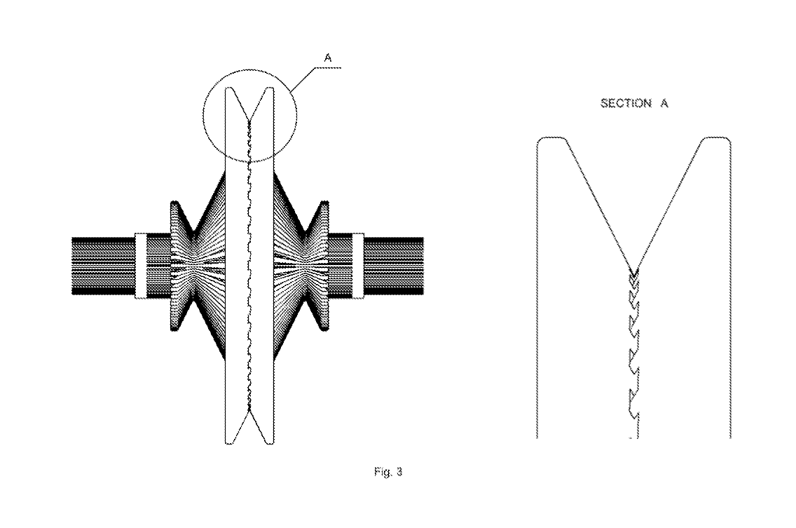

The claimed apparatus is capable of adjusting the smoothness of gear transmission ratios owing to the structural change of angle C (see FIG. 1). Moreover, in the claimed apparatus the precision of change of gear transmission ratios does not depend of the wear of the belt.

Although the present invention has been described with reference to specific exemplary embodiments, it will be evident that the various modification and changes can be made to these embodiments without departing from the broader spirit of the invention as set forth in the claims. Accordingly, the specification and drawirgs are to be regarded in an illustrative sense rather than in a restrictive sense

1. A V-belt continuously variable transmission comprising: a driving pulley and a driven pulley mounted on shafts, each of which pulleys consists of two half pulleys that are movable in a horizontal plane of the half pulleys, on which there are radial longitudinal through slots enabling the half pulleys to mate (penetrate) one another, and a drive belt, with that each half pulley is designed as a single component that consists of three solids of revolution with a common axis, which are interconnected as a single unit, two of said solids of revolution being different-sized hollow truncated cones oriented in different directions and connected by their smaller bases, and a third being a hub that is connected to the corresponding shaft in such a way as to be able to move along, the latter; and is designed as a hollow cylinder, a diameter of which coincides with the smaller base of the cones, the cylinder being adjoined by one of its tips to a lesser base of a bigger cone, whereas cut slots on the half pulleys are cut from a. bigger base of a lesser cone, not reaching a bigger base of the bigger cone, and on each of the hubs, from a tip joined to the lesser base of a bigger half pulley and not reaching another tip, corresponding longitudinal through slots are cut, which enable the half pulleys to mate (penetrate) one another while forming continuous surface at a center of each pulley, as the half pulleys mate (penetrate) each other up to an alignment of the lesser bases of half pulleys, and forming continuous surface on a periphery of the pulleys, as the half pulleys fully mate (penetrate) one another; wherein drive belt is made from flexible materials, enabling partial deformation of its surfaces that contact a surface of the pulleys, and achievement of the “cog wheel” effect.

2. The continuously variable transmission according to claim 1, wherein the hubs are connected to the shafts by the means of a spline joint.

3. The continuously variable transmission according to claim 1, wherein on surfaces of the drive belt that touch the surfaces of the half pulleys, along, the whole length of it, abutting metal elements are mounted.
